(19) United States
(12) Patent Application Publication
(10) Pub. No.: US 2021/0406395 A1
(43) Pub. Date: Dec. 30, 2021

(54) PERSONAL INFORMATION VAULT

(71) Applicant: AppDirect, Inc., San Francisco, CA (US)

(72) Inventors: Daniel P. Craggs, Montreal (CA); Vadim Rudman, Montreal (CA); David Lieu, Montreal (CA)

(21) Appl. No.: 16/914,148

(22) Filed: Jun. 26, 2020

(51) Int. Cl. G06F 21/62; G06F 21/71; H04L 29/06

(52) U.S. Cl. CPC G06F 21/6245; G06F 21/71; H04L 2463/082; H04L 63/108; H04L 63/08

(57) ABSTRACT

Various aspects of the subject technology relate to systems, methods, and machine-readable media for securely communicating personal information. The method includes receiving, from a user, personal information regarding the user. The method also includes storing the personal information in secure storage. The method also includes receiving, from a third party, a request for the personal information of the user. The method also includes receiving, from the user, authentication of the request for the personal information of the user. The method also includes in response to receiving the authentication, providing metadata to the third party comprising a promise to supply the personal information of the user, the metadata further comprising at least one of a timestamp, delta, or version number. The method also includes receiving, from a requestor, a notification for resolution of the promise, the notification identifying which of the personal information is required to complete a transaction.

### TECHNICAL FIELD

The present disclosure generally relates to protection of personal information, and more particularly to a personal information vault.

### BACKGROUND

Protecting personal information has become increasingly important, especially during a time where hackers are more sophisticated and widespread than ever before. The victims of hacking are not limited to individual people, but also include many high profile companies. In extreme cases, people's identities have been stolen based on the leaked personal information.

### BRIEF SUMMARY

The subject disclosure addresses shortcomings in existing technologies by providing for secure third party storage for personal information. According to an aspect, when an online service requires a user to register information, instead of the user entering personal information directly, the user may pass a reference to an account with a personal information vault. The user may authenticate with the personal information vault to prove that they are the owner of a vault account. The personal information vault may then act as a guarantor for the user's personal information. The personal information vault may provide a promise that the user has valid personal information and that the personal information vault will provide that information when it is requested. As a result, the online service only passes the promise around rather than the actual personal information of the user. This avoids the user's personal information being compromised during a data breach.

According to one embodiment of the present disclosure, a computer-implemented method is provided for securely communicating personal information. The method includes receiving, from a user, personal information regarding the user, the personal information comprising at least one of credit card information, address information, or identification information of the user. The method also includes storing the personal information in secure storage. The method also includes receiving, from a third party, a request for the personal information of the user. The method also includes receiving, from the user, authentication of the request for the personal information of the user. The method also includes in response to receiving the authentication, providing metadata to the third party comprising a promise to supply the personal information of the user, the metadata further comprising at least one of a timestamp, delta, or version number. The method also includes receiving, from a requestor, a notification for resolution of the promise, the notification identifying which of the personal information is required to complete a transaction.

According to one embodiment of the present disclosure, a system is provided including a processor and a memory comprising instructions stored thereon, which when executed by the processor, causes the processor to perform a method for securely communicating personal information. The method includes receiving, from a user, personal information regarding the user, the personal information comprising at least one of credit card information, address information, or identification information of the user. The method also includes storing the personal information in secure storage. The method also includes receiving, from a third party, a request for the personal information of the user. The method also includes receiving, from the user, authentication of the request for the personal information of the user. The method also includes in response to receiving the authentication, providing metadata to the third party comprising a promise to supply the personal information of the user, the metadata further comprising at least one of a timestamp, delta, or version number. The method also includes receiving, from a requestor, a notification for resolution of the promise, the notification identifying which of the personal information is required to complete a transaction.

According to one embodiment of the present disclosure, a non-transitory computer-readable storage medium is provided including instructions (e.g., stored sequences of instructions) that, when executed by a processor, cause the processor to perform a method for securely communicating personal information. The method includes receiving, from a user, personal information regarding the user, the personal information comprising at least one of credit card information, address information, or identification information of the user. The method also includes storing the personal information in secure storage. The method also includes receiving, from a third party, a request for the personal information of the user. The method also includes receiving, from the user, authentication of the request for the personal information of the user. The method also includes in response to receiving the authentication, providing metadata to the third party comprising a promise to supply the personal information of the user, the metadata further comprising at least one of a timestamp, delta, or version number. The method also includes receiving, from a requestor, a notification for resolution of the promise, the notification identifying which of the personal information is required to complete a transaction.

According to one embodiment of the present disclosure, a system is provided that includes means for storing instructions, and means for executing the stored instructions that, when executed by the means, cause the means to perform a method for securely communicating personal information. The method includes receiving, from a user, personal information regarding the user, the personal information comprising at least one of credit card information, address information, or identification information of the user. The method also includes storing the personal information in secure storage. The method also includes receiving, from a third party, a request for the personal information of the user. The method also includes receiving, from the user, authentication of the request for the personal information of the user. The method also includes in response to receiving the authentication, providing metadata to the third party comprising a promise to supply the personal information of the user, the metadata further comprising at least one of a timestamp, delta, or version number. The method also includes receiving, from a requestor, a notification for resolution of the promise, the notification identifying which of the personal information is required to complete a transaction.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an exemplary system for securely communicating personal information, according to certain aspects of the disclosure.

FIG. 2 illustrates an exemplary process flow for securely communicating personal information, according to certain aspects of the disclosure.

FIG. 3 illustrates a system configured for securely communicating personal information, according to certain aspects of the disclosure.

FIG. 4 illustrates an example flow chart for securely communicating personal information, according to certain aspects of the disclosure.

FIG. 5 is a block diagram illustrating an example computer system (e.g., representing both client and server) with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

The protection of personal information has become increasingly important, especially during a time where hackers are more sophisticated and widespread than ever before. The victims of hacking are not limited to individual people, but also include many high profile companies. In extreme cases, people's identities have been stolen based on the leaked personal information. Therefore, there is a need for a secure way of storing and disseminating personal information.

Aspects of the present disclosure address these issues by providing for secure third party storage of personal information. In an implementation, when an online service requires a user to register information, instead of the user entering the personal information directly, the user may pass a reference to an account with a personal information vault. The user may authenticate with the personal information vault to prove that they are the owner of a vault account. The personal information vault may then act as a guarantor for the user's personal information. The personal information vault may provide a promise that the user has valid personal information and that the personal information vault will provide that information when it is requested. As a result, the online service only obtains the promise rather than the actual personal information of the user. This avoids the user's personal information being compromised during a data breach.

In an implementation, when the online service requires the personal information (e.g., perhaps the user has bought something online and now requires delivery, so a delivery address is needed), the online service may contact the personal information vault. For example, the online service may contact the personal information vault through a REST API, or the like. The online service may also pass along the promise information it received. The personal information vault may then send a push notification via an online application to the user (e.g., on the user's mobile phone or other device) and the user can either approve or deny the online service's access to their address.

According to aspects, the online service may pass the promise metadata onto a payment processor (or other third party) if they have no need to resolve it themselves. For example, the online service may forward a payment to a payment processor without ever having to handle the payment details themselves.

The disclosed system addresses a problem in traditional personal information security tied to computer technology, namely, the technical problem of safely and securely storing and disseminating personal information. The disclosed system solves this technical problem by providing a solution also rooted in computer technology, namely, by providing for a personal information vault. The disclosed subject technology further provides improvements to the functioning of the computer itself because it improves processing and efficiency in online transactions.

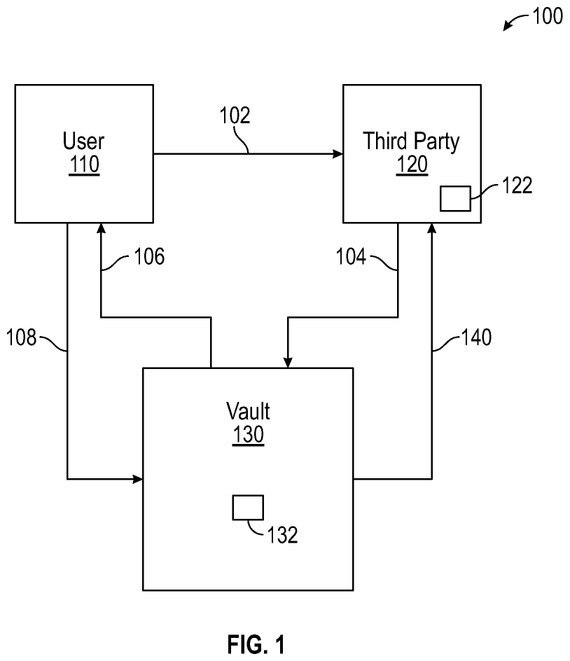

FIG. 1 illustrates an exemplary system 100 for securely communicating personal information, according to certain aspects of the disclosure. The system 100 may include a user 110, a third party 120, and a vault 130 (e.g., a personal information vault). For example, the third party 120 may include vendors of online services, and the like. The vault 130 may be configured to securely store personal information 132 of the user 110. Both the user 110 and the third party 120 may be communicatively coupled to the vault 130, for example, via the Internet.

According to aspects, the user 110 may sign up to an online service of the third party 120 that requires personal information. For example, the personal information may include at least one of credit card information, address information, or identification information of the user. For example, the identification information may include the user's legal name, social security number, driver's license, passport, etc. It is understood that these are exemplary only, and additional information regarding the user may be included as personal information without departing from the scope of the disclosure.

The user 110 may provide to the third party 120 a reference 102 to the vault 130. For example, the user 110 may previously have already created an account with the vault 130 to have the vault 130 securely store the user's personal information 132. The reference 102 may include an account reference number of the user 110 with the vault 130.

The third party 120 may contact 104 the vault 130 through the reference 102 of the user 110 and notify the vault 130 which specific personal data 132 will be required. For example, the third party 120 may require credit card information, but not user address information, because the user 110 is only opening an account with the third party 120 and nothing is being delivered yet to the user 110.

Once the vault 130 is contacted by the third party 120 regarding dissemination of the specific personal data 132, the vault 130 may request authentication from the user 110 to confirm that the transaction is legitimate. For example, the vault 130 may send a message 106 to the user 110 asking for authentication of the request by the third party 120. For example, the message 106 may include a push notification, SMS message, e-mail, or the like. The user 110 may then choose whether to authenticate the request.

According to aspects, the user 110 may authenticate by logging into their vault account and/or through two-factor authentication, or the like. If authenticated, the vault 130 receives the authentication 108 from the user 110 and may proceed with providing a promise 140 to the third party 120. For example, the promise 140 may include a verification to supply any required personal information 132 at a later time when the personal information 132 is needed. The promise 140 may also include metadata, such as a timestamp, delta, version number, etc. The promise 140 may also include multiple promises for multiple pieces of personal information 132.

In an implementation, the user 110 currently has not purchased anything, and so no personal information 132 is needed. For example, the user 110 may only be opening an account 122 with the third party 120, and so the third party 120 may only be requesting the personal information 132 for use at a later time. Because of that, the promise 140 will serve to satisfy the requirement of opening the account 122.

According to aspects, at a later time, an action may be taken by the third party 120 that requires the personal information 132. For example, a payment may need to be made that requires a credit card or other payment information, a delivery may need to be sent out that requires an address, etc. The third party 120 may then send a request (e.g., via an asynchronous API call) to the vault 130 for resolution of the promise 140. The vault 130 may then send a notification (e.g., a push notification, or the like) to the user 110, specifying that the third party 120 wants to access the personal information 132, which specific personal information they need, and, optionally, for what purpose. The user 110 may then approve the request, and the vault 130 may then send the relevant personal information 132 over an encrypted channel to the third party 120. The third party 120 may then utilize the personal information 132 to complete the transaction. According to aspects, once the transaction is completed, the third party 120 discards (e.g., deletes) the personal information 132 it received, and sends confirmation to the vault 130 that the received personal information 132 was discarded.

In an embodiment, the user 110 may specify a time-limited window (e.g., a time limit) that allows the third party 120 to access the requested data (e.g., the personal information 132) from the vault 130 only during this time. For example, the time limit may be a few seconds or a few minutes, or longer depending on sensitivity of the personal information 132. In an implementation, more time may be allowed for accessing less sensitive information (e.g., user's address, user's full legal name, etc.) than more sensitive information (e.g., social security number, credit card number, etc.). In another embodiment, the user 110 may specify a total number of times the vault 130 will allow access to the relevant data (e.g., the personal information 132). In another embodiment, the user 110 may allow unlimited access to the vault 130.

According to additional aspects, snapshots of the personal information 132 may be taken intermittently because that data (e.g., the personal information 132) may change over time. The snapshots may include a date and time at which each snapshot was taken. For example, credit cards may be added/removed/expired, address(es) may have changed, etc. In this way the vault 130 may store the data and its changes over time. In an implementation, the promise metadata may include a timestamp or a difference reference (e.g., similar to a git commit) to ensure the third party 120 receives the data in the form that was promised. This way, a user 110 who updates a credit card in the vault 130 does not inadvertently redirect a payment that was promised before the update to the new credit card.

According to additional aspects, the promise 140 may include an encrypted hash and/or key value pair based on a secret that is shared between the user 110 and the vault 130. For example, the shared secret may be based on the personal information 132, such as a credit card number, etc. This way, updating the personal information 132 would also update the hash. At the later time, when the third party 120 requires resolution of the promise 140, the hash may be passed back to the vault 130. The vault 130 may then look up the hash and retrieve the relevant data (e.g., requested personal information 132) associated with the hash.

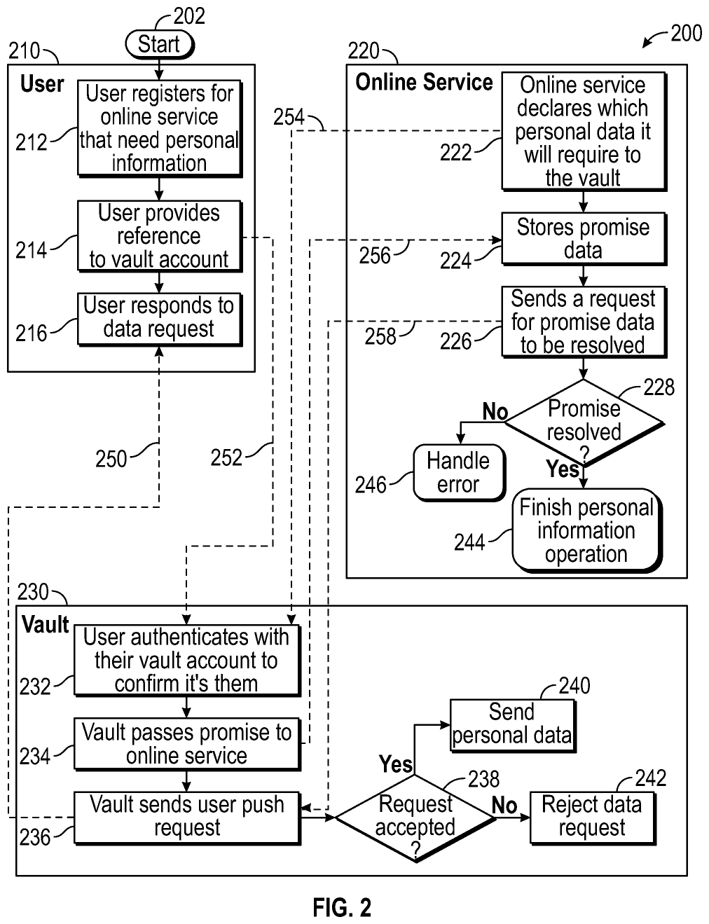

FIG. 2 illustrates an exemplary process flow 200 for securely communicating personal information, according to certain aspects of the disclosure. The process flow 200 include interactions between a user 210, an online service 220 (e.g., a third party), and a vault service 230 (e.g., a personal information vault). According to an aspect, the user 210 has already registered with the vault service 230, and the user 210 is going to sign into the vault service 230 by interacting with the online service 220.

According to aspects, the process flow 200 may begin at block 202 with the user 210 registering, at block 212, for the online service 220 that requires submission of personal information (e.g., personal information 132). For example, the user 210 may be filling out an online form regarding the online service 220. Instead of providing the personal information directly when filling out the online form, the user provides a reference to the user's vault account, at block 214. For example, the online service 220 may be configured to accept vault information, and so the user 210 provides the reference to the online service 220.

At this point the user 210 may be forwarded 252 on to authenticate with the vault 230, to confirm, at block 232, that it is the user 210. The online service 220 may also utilize the provided reference 220 to contact 254 the vault 230 and declare which personal data the online service will require, at block 222. The vault 230 then provides a promise 256 to the online service 220 that the personal data will be given at a later time when it is needed, at block 234. For example, the promise 256 may include a promise to provide personal information including, but not limited to, at least one of an address, a credit card number, etc., to the online service 220. In response, the online service 220 stores the promise data, at block 224, and allows the user 210 to complete registration.

According to aspects, at a later time, the online service 220 may send a request 258 to the vault 230 to have the promise resolved, at block 226. For example, the user 210 may have purchased an item/service, so now the credit card information and delivery address (if applicable) needs to be resolved (e.g., passed onto a payment processor) in order to complete the purchase. In response to receiving the request 258 from the online service 220, the vault 230 send a request 250 to the user 210 to authorize release of the personal information, at block 236. For example, the request 250 may include a push notification, or the like. The user 210 may then respond to the data request, at block 216, by either confirming or denying the transaction. For example, the request 250 may specify that the online service 220 requires the user's credit card number and delivery address.

The vault 230 may then determine whether the request 250 was authorized or not, at block 238. If the request 250 is not authorized, then the vault 230 rejects the data request, at block 242. If the request 250 is authorized, then the vault 230 sends the personal data to the online service 220, at block 240. According to aspects, the user 210 may specify limits regarding the personal information. For example, the user 210 may specify that the online service 220 may only receive the credit card information for just this one time. According to aspects, the user 210 may also specify that the online service 220 has access to the personal information for a time period (e.g., an hour), a predefined number of times (e.g., five times), or unlimited access.

At block 228, the online service 220 determines whether the promise was resolved. If yes, then the transaction is completed, at block 244. For example, the online service 220 may then proceed to ship/provide the ordered item to the user 210 based on the personal information received. If no, then there is a promise resolution failure, at block 246. For example, the online service 220 may handle the failure in their own way, such as through an e-mail to the user 210 that notifies the user 210 that the order failed. According to aspects, the online service 220 may prompt the user 210 to approve the vault request in order to complete the transaction. Otherwise, the transaction will not be completed.

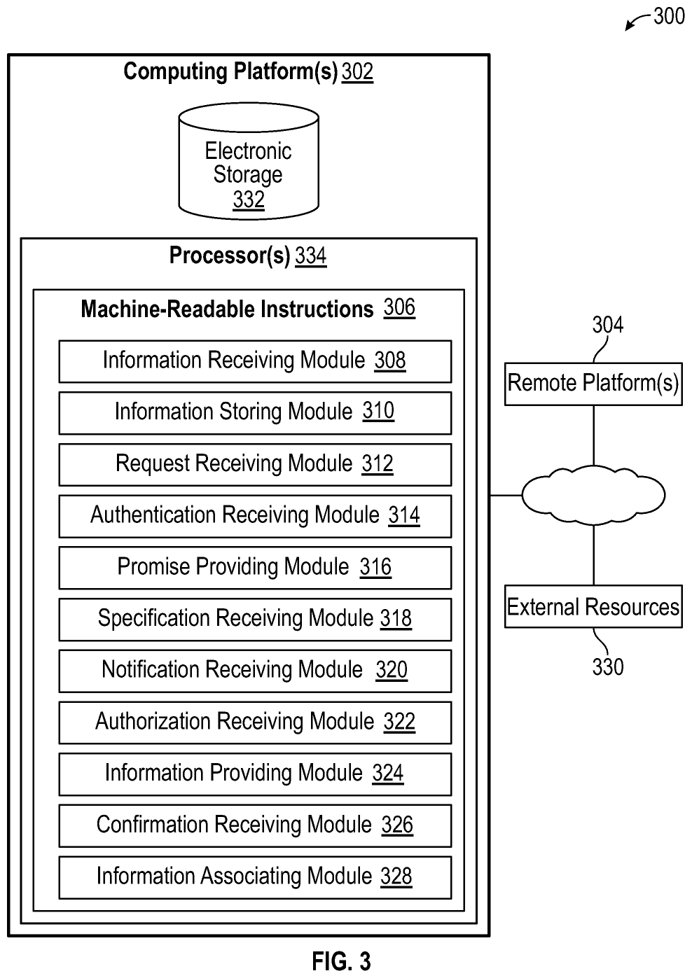

FIG. 3 illustrates a system 300 configured for securely communicating personal information, in accordance with one or more implementations. In some implementations, system 300 may include one or more computing platforms 302. Computing platform(s) 302 may be configured to communicate with one or more remote platforms 304 according to a client/server architecture, a peer-to-peer architecture, and/or other architectures. Remote platform(s) 304 may be configured to communicate with other remote platforms via computing platform(s) 302 and/or according to a client/server architecture, a peer-to-peer architecture, and/or other architectures. Users may access system 300 via remote platform(s) 304.

Computing platform(s) 302 may be configured by machine-readable instructions 306. Machine-readable instructions 306 may include one or more instruction modules. The instruction modules may include computer program modules. The instruction modules may include one or more of information receiving module 308, information storing module 310, request receiving module 312, authentication receiving module 314, promise providing module 316, specification receiving module 318, notification receiving module 320, authorization receiving module 322, information providing module 324, confirmation receiving module 326, information associating module 328, and/or other instruction modules.

Information receiving module 308 may be configured to receive, from a user, personal information regarding the user. The alert including which of the personal information is may be requested. By way of non-limiting example, the personal information may include at least one of credit card information, address information, or identification information of the user.

Information storing module 310 may be configured to store the personal information in secure storage.

Request receiving module 312 may be configured to receive, from a third party, a request for the personal information of the user.

Authentication receiving module 314 may be configured to receive, from the user, authentication of the request for the personal information of the user. The authentication may include two-factor authentication. Receiving the authentication from the user may further include sending, to the user, an alert that the personal information is being requested. The alert may include a push notification.

Promise providing module 316 may be configured to, in response to receiving the authentication, provide a promise to the third party to supply the personal information of the user. By way of non-limiting example, the promise may include metadata including at least one of a timestamp, delta, or version number.

Specification receiving module 318 may be configured to receive, from the user, a specification of a time limit during which the personal information of the user may be accessed.

Notification receiving module 320 may be configured to receive, from a requestor, a notification for resolution of the promise. The notification may identify which of the personal information is required to complete a transaction. The personal information may be deleted by the requestor after the transaction is completed.

Authorization receiving module 322 may be configured to receive, from the user, authorization to proceed with supplying the personal information.

Information providing module 324 may be configured to, in response to receiving the authorization, provide the personal information of the user to the requestor.

Confirmation receiving module 326 may be configured to receive, from the requestor, confirmation of deletion of the personal information by the requestor.

Information associating module 328 may be configured to associate the personal information of the user with an account reference number for the user. The account reference number may be utilized by the user to complete online transactions in lieu of directly providing the personal information of the user.

In some implementations, computing platform(s) 302, remote platform(s) 304, and/or external resources 330 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 302, remote platform(s) 304, and/or external resources 330 may be operatively linked via some other communication media.

A given remote platform 304 may include one or more processors configured to execute computer program modules. The computer program modules may be configured to enable an expert or user associated with the given remote platform 304 to interface with system 300 and/or external resources 330, and/or provide other functionality attributed herein to remote platform(s) 304. By way of non-limiting example, a given remote platform 304 and/or a given computing platform 302 may include one or more of a server, a desktop computer, a laptop computer, a handheld computer, a tablet computing platform, a NetBook, a Smartphone, a gaming console, and/or other computing platforms.

External resources 330 may include sources of information outside of system 300, external entities participating with system 300, and/or other resources. In some implementations, some or all of the functionality attributed herein to external resources 330 may be provided by resources included in system 300.

Computing platform(s) 302 may include electronic storage 332, one or more processors 334, and/or other components. Computing platform(s) 302 may include communication lines, or ports to enable the exchange of information with a network and/or other computing platforms. Illustration of computing platform(s) 302 in FIG. 3 is not intended to be limiting. Computing platform(s) 302 may include a plurality of hardware, software, and/or firmware components operating together to provide the functionality attributed herein to computing platform(s) 302. For example, computing platform(s) 302 may be implemented by a cloud of computing platforms operating together as computing platform(s) 302.

Electronic storage 332 may comprise non-transitory storage media that electronically stores information. The electronic storage media of electronic storage 332 may include one or both of system storage that is provided integrally (i.e., substantially non-removable) with computing platform(s) 302 and/or removable storage that is removably connectable to computing platform(s) 302 via, for example, a port (e.g., a USB port, a firewire port, etc.) or a drive (e.g., a disk drive, etc.). Electronic storage 332 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 332 may include one or more virtual storage resources (e.g., cloud storage, a virtual private network, and/or other virtual storage resources). Electronic storage 332 may store software algorithms, information determined by processor(s) 334, information received from computing platform(s) 302, information received from remote platform(s) 304, and/or other information that enables computing platform(s) 302 to function as described herein.

Processor(s) 334 may be configured to provide information processing capabilities in computing platform(s) 302. As such, processor(s) 334 may include one or more of a digital processor, an analog processor, a digital circuit designed to process information, an analog circuit designed to process information, a state machine, and/or other mechanisms for electronically processing information. Although processor(s) 334 is shown in FIG. 3 as a single entity, this is for illustrative purposes only. In some implementations, processor(s) 334 may include a plurality of processing units. These processing units may be physically located within the same device, or processor(s) 334 may represent processing functionality of a plurality of devices operating in coordination. Processor(s) 334 may be configured to execute modules 308, 310, 312, 314, 316, 318, 320, 322, 324, 326, and/or 328, and/or other modules. Processor(s) 334 may be configured to execute modules 308, 310, 312, 314, 316, 318, 320, 322, 324, 326, and/or 328, and/or other modules by software; hardware; firmware; some combination of software, hardware, and/or firmware; and/or other mechanisms for configuring processing capabilities on processor(s) 334. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 308, 310, 312, 314, 316, 318, 320, 322, 324, 326, and/or 328 are illustrated in FIG. 3 as being implemented within a single processing unit, in implementations in which processor(s) 334 includes multiple processing units, one or more of modules 308, 310, 312, 314, 316, 318, 320, 322, 324, 326, and/or 328 may be implemented remotely from the other modules. The description of the functionality provided by the different modules 308, 310, 312, 314, 316, 318, 320, 322, 324, 326, and/or 328 described below is for illustrative purposes, and is not intended to be limiting, as any of modules 308, 310, 312, 314, 316, 318, 320, 322, 324, 326, and/or 328 may provide more or less functionality than is described. For example, one or more of modules 308, 310, 312, 314, 316, 318, 320, 322, 324, 326, and/or 328 may be eliminated, and some or all of its functionality may be provided by other ones of modules 308, 310, 312, 314, 316, 318, 320, 322, 324, 326, and/or 328. As another example, processor(s) 334 may be configured to execute one or more additional modules that may perform some or all of the functionality attributed below to one of modules 308, 310, 312, 314, 316, 318, 320, 322, 324, 326, and/or 328.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

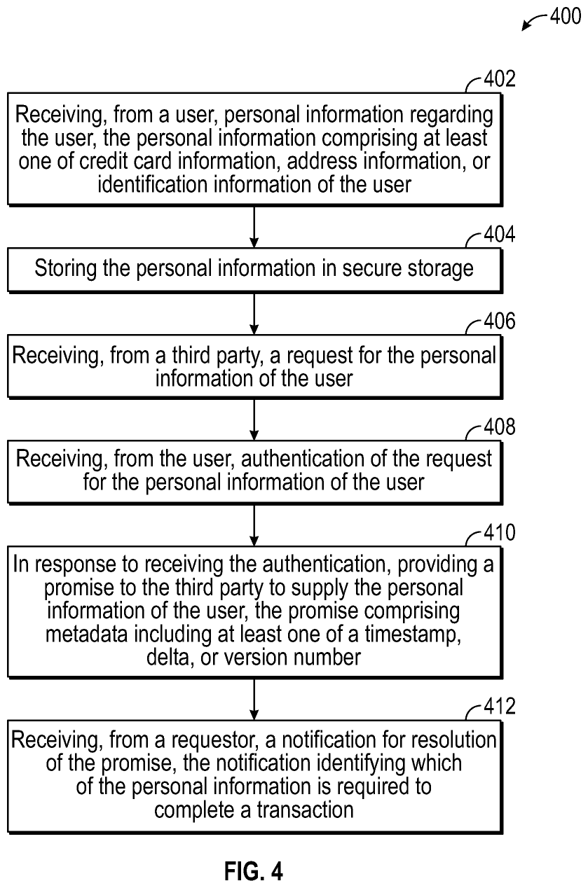

FIG. 4 illustrates an example flow chart (e.g., process 400) for securely communicating personal information, according to certain aspects of the disclosure. For explanatory purposes, the example process 400 is described herein with reference to FIGS. 1 and 2. Further for explanatory purposes, the steps of the example process 400 are described herein as occurring in serial, or linearly. However, multiple instances of the example process 400 may occur in parallel. For purposes of explanation of the subject technology, the process 400 will be discussed in reference to FIGS. 1 and 2.

At step 402, personal information regarding a user is received from the user, the personal information comprising at least one of credit card information, address information, or identification information of the user. At step 404, the personal information is stored in secure storage. At step 406, a request for the personal information of the user is received from a third party. At step 408, authentication of the request for the personal information of the user is received from the user. At step 410, in response to receiving the authentication, a promise (e.g., metadata) is provided to the third party to supply the personal information of the user, the promise comprising metadata including at least one of a timestamp, delta, or version number. At step 412, a notification is received from a requestor for resolution of the promise, the notification identifying which of the personal information is required to complete a transaction.

For example, as described above in relation to FIGS. 1 and 2, at step 402, personal information (e.g., personal information 132) regarding a user (e.g., user 110, 210) is received from the user, the personal information comprising at least one of credit card information, address information, or identification information of the user. At step 404, the personal information is stored in secure storage (e.g., vault 130, 230). At step 406, a request (e.g., request 104) for the personal information of the user is received from a third party (e.g., third party 120, 220). At step 408, authentication (e.g., authentication 108) of the request for the personal information of the user is received from the user. At step 410, in response to receiving the authentication, a promise (e.g., promise 140, 256) is provided to the third party to supply the personal information of the user, the promise comprising metadata including at least one of a timestamp, delta, or version number. At step 412, a notification is received from a requestor (e.g., third party 120) for resolution of the promise, the notification identifying which of the personal information is required to complete a transaction.

According to an aspect, the authentication comprises two-factor authentication. According to an aspect, the process 400 further includes receiving, from the user, a specification of a time limit during which the personal information of the user may be accessed.

According to an aspect, the process 400 further includes receiving, from a requestor, a notification for resolution of the promise, the notification identifying which of the personal information is required to complete a transaction. The process 400 may further include receiving, from the user, authorization to proceed with supplying the personal information. The process 400 may further include, in response to receiving the authorization, providing the personal information of the user to the requestor.

According to an aspect, the personal information is deleted by the requestor after the transaction is completed. According to an aspect, the process 400 further includes receiving, from the requestor, confirmation of deletion of the personal information by the requestor.

According to an aspect, receiving the authentication from the user further comprises sending, to the user, an alert that the personal information is being requested, the alert comprising which of the personal information is being requested. According to an aspect, the alert comprises a push notification.

According to an aspect, the process 400 further includes associating the personal information of the user with an account reference number for the user. According to an aspect, the account reference number is utilized by the user to complete online transactions/registrations in lieu of directly providing the personal information of the user.

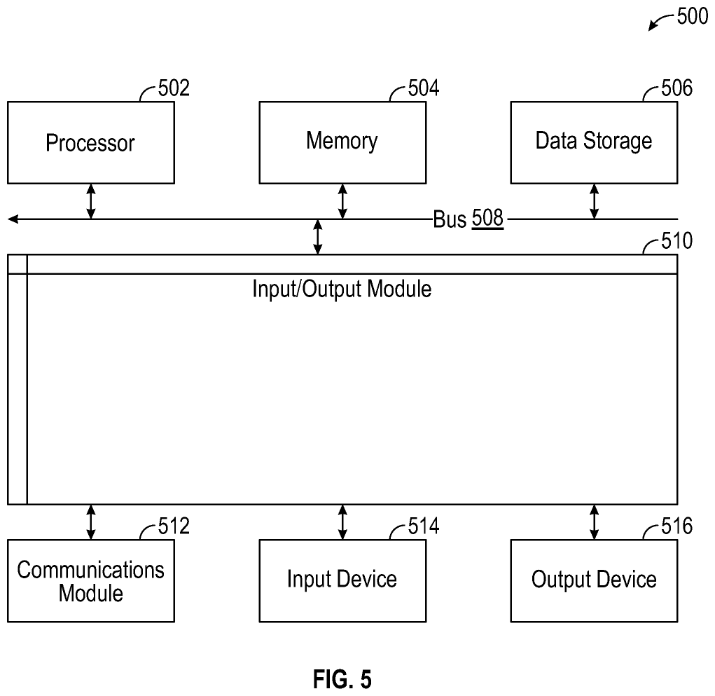

FIG. 5 is a block diagram illustrating an exemplary computer system 500 with which aspects of the subject technology can be implemented. In certain aspects, the computer system 500 may be implemented using hardware or a combination of software and hardware, either in a dedicated server, integrated into another entity, or distributed across multiple entities.

Computer system 500 (e.g., server and/or client) includes a bus 508 or other communication mechanism for communicating information, and a processor 502 coupled with bus 508 for processing information. By way of example, the computer system 500 may be implemented with one or more processors 502. Processor 502 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 500 can include, in addition to hardware, code that creates an execution environment for the computer program in question, e.g., code that constitutes processor firmware, a protocol stack, a database management system, an operating system, or a combination of one or more of them stored in an included memory 504, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 508 for storing information and instructions to be executed by processor 502. The processor 502 and the memory 504 can be supplemented by, or incorporated in, special purpose logic circuitry.

The instructions may be stored in the memory 504 and implemented in one or more computer program products, i.e., one or more modules of computer program instructions encoded on a computer-readable medium for execution by, or to control the operation of, the computer system 500, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 504 may also be used for storing temporary variable or other intermediate information during execution of instructions to be executed by processor 502.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 500 further includes a data storage device 506 such as a magnetic disk or optical disk, coupled to bus 508 for storing information and instructions. Computer system 500 may be coupled via input/output module 510 to various devices. The input/output module 510 can be any input/output module. Exemplary input/output modules 510 include data ports such as USB ports. The input/output module 510 is configured to connect to a communications module 512. Exemplary communications modules 512 include networking interface cards, such as Ethernet cards and modems. In certain aspects, the input/output module 510 is configured to connect to a plurality of devices, such as an input device 514 and/or an output device 516. Exemplary input devices 514 include a keyboard and a pointing device, e.g., a mouse or a trackball, by which a user can provide input to the computer system 500. Other kinds of input devices 514 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 516 include display devices such as an LCD (liquid crystal display) monitor, for displaying information to the user.

According to one aspect of the present disclosure, the above-described gaming systems can be implemented using a computer system 500 in response to processor 502 executing one or more sequences of one or more instructions contained in memory 504. Such instructions may be read into memory 504 from another machine-readable medium, such as data storage device 506. Execution of the sequences of instructions contained in the main memory 504 causes processor 502 to perform the process steps described herein. One or more processors in a multi-processing arrangement may also be employed to execute the sequences of instructions contained in memory 504. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 500 can include clients and servers. A client and server are generally remote from each other and typically interact through a communication network. The relationship of client and server arises by virtue of computer programs running on the respective computers and having a client-server relationship to each other. Computer system 500 can be, for example, and without limitation, a desktop computer, laptop computer, or tablet computer. Computer system 500 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 502 for execution. Such a medium may take many forms, including, but not limited to, non-volatile media, volatile media, and transmission media. Non-volatile media include, for example, optical or magnetic disks, such as data storage device 506. Volatile media include dynamic memory, such as memory 504. Transmission media include coaxial cables, copper wire, and fiber optics, including the wires that comprise bus 508. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 500 reads game data and provides a game, information may be read from the game data and stored in a memory device, such as the memory 504. Additionally, data from the memory 504 servers accessed via a network or the bus 508, or the data storage 506 may be read and loaded into the memory 504. Although data is described as being found in the memory 504, it will be understood that data does not have to be stored in the memory 504 and may be stored in other memory accessible to the processor 502 or distributed among several media, such as the data storage 506.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A computer-implemented method for securely communicating personal information, comprising:
receiving, from a user, personal information regarding the user, the personal information comprising at least one of credit card information, address information, or identification information of the user;
storing the personal information in secure storage;
receiving, from a third party, a request for the personal information of the user;
receiving, from the user, authentication of the request for the personal information of the user;
in response to receiving the authentication, providing metadata to the third party comprising a promise to supply the personal information of the user, the metadata further comprising at least one of a timestamp, delta, or version number; and
receiving, from a requestor, a notification for resolution of the promise, the notification identifying which of the personal information is required to complete a transaction.

2. The computer-implemented method of claim 1, wherein the authentication comprises two-factor authentication.

3. The computer-implemented method of claim 1, further comprising:
receiving, from the user, a specification of a time limit during which the personal information of the user may be accessed.

4. The computer-implemented method of claim 1, further comprising:
receiving, from the user, authorization to proceed with supplying the personal information; and
in response to receiving the authorization, providing the personal information of the user to the requestor.

5. The computer-implemented method of claim 1, wherein the personal information is deleted by the requestor after the transaction is completed.

6. The computer-implemented method of claim 1, further comprising:
receiving, from the requestor, confirmation of deletion of the personal information by the requestor.

7. The computer-implemented method of claim 1, wherein receiving the authentication from the user further comprises:
sending, to the user, an alert that the personal information is being requested, the alert comprising which of the personal information is being requested.

8. The computer-implemented method of claim 7, wherein the alert comprises a push notification.

9. The computer-implemented method of claim 1, further comprising:
associating the personal information of the user with an account reference number for the user.

10. The computer-implemented method of claim 9, wherein the account reference number is utilized by the user in lieu of directly providing the personal information of the user.

11. A system for securely communicating personal information, comprising:
a processor; and
a memory comprising instructions stored thereon, which when executed by the processor, causes the processor to perform:
receiving, from a user, personal information regarding the user, the personal information comprising at least one of credit card information, address information, or identification information of the user;
storing the personal information in secure storage;
receiving, from a third party, a request for the personal information of the user;
receiving, from the user, authentication of the request for the personal information of the user;
in response to receiving the authentication, providing metadata to the third party comprising a promise to supply the personal information of the user, the metadata further comprising at least one of a timestamp, delta, or version number; and
receiving, from a requestor, a notification for resolution of the promise, the notification identifying which of the personal information is required to complete a transaction.

12. The system of claim 11, wherein the authentication comprises two-factor authentication.

13. The system of claim 11, further comprising stored sequences of instructions, which when executed by the processor, cause the processor to perform:
receiving, from the user, a specification of a time limit during which the personal information of the user may be accessed.

14. The system of claim 11, further comprising stored sequences of instructions, which when executed by the processor, cause the processor to perform:
receiving, from the user, authorization to proceed with supplying the personal information; and
in response to receiving the authorization, providing the personal information of the user to the requestor.

15. The system of claim 11, wherein the personal information is deleted by the requestor after the transaction is completed.

16. The system of claim 15, further comprising stored sequences of instructions, which when executed by the processor, cause the processor to perform:
receiving, from the requestor, confirmation of deletion of the personal information by the requestor.

17. The system of claim 11, further comprising stored sequences of instructions, which when executed by the processor, cause the processor to perform:
sending, to the user, an alert that the personal information is being requested, the alert comprising which of the personal information is being requested.

18. The system of claim 17, wherein the alert comprises a push notification.

19. The system of claim 11, further comprising stored sequences of instructions, which when executed by the processor, cause the processor to perform:
associating the personal information of the user with an account reference number for the user.

20. A non-transitory computer-readable storage medium is provided including instructions that, when executed by a processor, causes the processor to perform a method for securely communicating personal information, comprising:
receiving, from a user, personal information regarding the user, the personal information comprising at least one of credit card information, address information, or identification information of the user;
storing the personal information in secure storage;
receiving, from a third party, a request for the personal information of the user;
receiving, from the user, authentication of the request for the personal information of the user;
in response to receiving the authentication, providing metadata to the third party comprising a promise to supply the personal information of the user, the metadata further comprising at least one of a timestamp, delta, or version number; and
receiving, from a requestor, a notification for resolution of the promise, the notification identifying which of the personal information is required to complete a transaction.
